(19) United States
(12) Patent Application Publication
(10) Pub. No.: US 2024/0141966 A1
(43) Pub. Date: May 2, 2024

(54) SYSTEMS AND METHODS FOR DAMPENING VIBRATIONS

(71) Applicant: Theodore Joseph Stack, Newton Abbot (GB)

(72) Inventor: Theodore Joseph Stack, Newton Abbot (GB)

(21) Appl. No.: 18/384,959

(22) Filed: Oct. 30, 2023

Related U.S. Application Data
(60) Provisional application No. 63/421,984, filed on Nov. 2, 2022.

(51) Int. Cl. F16F 7/01

(52) U.S. Cl. CPC F16F 7/01; F16F 2230/30

(57) ABSTRACT

A particle damping assembly designed provides enhanced vibration control, especially for use with sound systems. The assembly comprises a housing encompassing multiple containers. Each container is designed to hold particles of varying sizes that contribute to the particle impact damping effect, offering improved sound quality by mitigating unwanted vibrations.

### PRIORITY CLAIM

This non-provisional patent application claims the benefit of U.S. Provisional Application No. 63/421,984 filed on Nov. 2, 2022, the entirety of which is incorporated herein by reference.

### FIELD

The present disclosure relates generally to dampening vibrations. More particularly, the present disclosure relates to assemblies, systems, and methods to dampen vibrations in a sound system.

### BACKGROUND

Components of a high-fidelity sound system frequently vibrate. Such vibration may come, for example, from mechanical components of a sound system. Additional or alternatively, vibration may also come from a surface that sound system components are resting on. Unwanted vibration may also come from other objects not related to the sound system.

A high-fidelity system, also known as high fidelity audio, or HiFi audio, is audio that is very high quality. The factors that play into this level of quality are a high accuracy at reproducing the audible frequencies in an audio recording, with limited distortion in the original audio signal. HiFi has been described as sounding clear, clean, crisp, and free from distortion and other unwanted sonic artifacts. This in general is what high fidelity or “HiFi” means.

Vibration in loudspeakers may also cause distortion of the desired HiFi audio. A common type of HiFi loudspeaker is the dynamic driver design. This design works in part by using an electrical current from the amplifier to move a voice coil held in place in a permanent magnetic field. The voice coil is attached to a diaphragm that moves back and forth creating the soundwaves. The speaker drivers are mounted in a cabinet of housing. There are many different types of drivers, configurations, and cabinet/housing designs which work on the same basic principle.

The soundwaves (which comprise vibrations and energy) ideally will excite only the air rather than the body of the speaker and the floorboards, furniture, walls, and the like. However, what also happens is that the energy travels down the speaker cabinet/housing (and speaker stand if used) into the floor and the furniture. This then makes the room and surrounding structures, such as, for example but not by way of limitation, floorboards, walls, furniture, act as radiating surfaces which distorts the audible soundwaves and creates vibrations that effect the other HiFi components (turntable and electronics) creating electronic and digital noise degrading the audio signal. Noise can also enter the speaker from external sources such as white goods, traffic noise, and the like.

Vibrations affect the nature and quality audio reproduction. Vibrations from loudspeaker cabinets can cause echoes, timing smears and a reduction in clarity of the audible sound signal, impairing the accurate reproduction of the music. Vibrations, when transmitted through room structures like floors or walls, can cause such structures to emit secondary sound radiations or resonances, interfering with the primary audio signal. Controlling and dampening these vibrations is important to preserving the true essence and quality of HiFi audio playback.

Vinyl record players or turntables and other electronic components are susceptible to loudspeaker induced vibrations and can themselves also cause unwanted vibration. Electrical audio equipment, for example, but not by limitation, CD players, digital sources, tuners, amplifiers, and the like, also suffer from vibration induced distortion, known as microphony. Vacuum tubes, crystal oscillators (clocks), capacitors and other electrical components used inside these units are also susceptible. This includes certain types of digital devices such as CD players, music streamers, PCs and laptops, since they rely on digital clocks and other components which are exposed to microphony such that vibration creates electrical interference that creates jitter (unwanted digital noise and timing errors).

For speakers to work effectively, one needs to satisfy two seemingly contradictory aims: hold the loudspeaker perfectly rigidly whist absorbing vibration at the same time. It would be desirable to have an assembly, system and/or methods to dampen vibrations, particularly in order to dampen vibrations to enhance the quality of HiFi music. Such an assembly, system or method would permit individual control of an assembly that would dampen vibrations for HiFi sound or music but not itself introduce other distortions to the music by for example allowing movement in the speaker cabinet.

Particle impact dampening (PID) is a technology that employs particles held within a confined space or chamber that collide with each other and the chamber walls when subjected to vibrations. The collisions dissipate the vibrational energy by turning it into heat.

The presently disclosed embodiments for loudspeaker isolators are both rigid, providing the benefits of coupling to prevent movement of the speaker, whilst absorbing speaker cabinet vibration internally through the application of particle impact dampening (PID). The various disclosed embodiments for an equipment isolator intentionally allows movement.

### SUMMARY

According to an exemplary arrangement, a particle damping assembly comprises a housing, a plurality of containers positioned within the housing, the plurality of containers configured to hold a plurality of particles for particle impact damping of vibrations, and one or more sizes of particles, each size of particle held within the plurality of containers.

In one exemplary embodiment, the plurality of containers comprises a first container and a second container wherein the first container is stacked on top of the second container.

In one exemplary embodiment, the plurality of containers comprises a third container wherein the second container is stacked on top of the third container.

In one exemplary embodiment, the plurality of containers comprises a fourth container wherein the third container is stacked on top of the fourth container.

In one exemplary embodiment, the assembly further comprising a third container, wherein the third container is positioned in adjacent the first container and the second container.

In one exemplary embodiment, the plurality of containers comprises a first container and a second container wherein the first container and the second container are positioned side-by-side each other.

In one exemplary embodiment, the assembly further comprising a third container wherein the third container is positioned adjacent either the first container or the second container.

In one exemplary embodiment, the assembly further comprising a third container wherein the third container is positioned in between the first container or the second container.

In one exemplary embodiment, the assembly further comprising an insert positioned between a first container and a second container of the plurality of containers.

In one exemplary embodiment, the assembly further comprising an insert positioned between a surface of a housing of a component of a sound system and at least one of the plurality of containers.

In one exemplary embodiment, at least one of the containers of the plurality of containers is formed from aluminum, stainless steel, or plastic.

In one exemplary embodiment, the particles are formed from at least one of steel, iron, tungsten, glass, or ceramic.

In one exemplary embodiment, the particles have a size in a range of about 0.0001 millimeters to about 4.0 millimeters.

In one exemplary embodiment, the particles comprise multi-frequency impact dampening particles.

In one exemplary embodiment, at least one of the plurality of containers comprises a ring-shaped container containing the particle impact dampeners.

In one exemplary embodiment, the housing comprises a machined metal housing or a stainless-steel main housing.

In one exemplary embodiment, the dampeners comprise a particle size ranging from about 0.0001 millimeters to about 4.0 millimeters.

In one exemplary embodiment, the assembly comprises an assembly for dampening vibration in a sound system.

In one exemplary embodiment, a first container of the plurality of containers defines a first volume and a second container of the plurality of containers defines a second volume, wherein the second volume is not substantially the same as the first volume.

In one exemplary embodiment, the housing defines a first surface, wherein the first surface is provided with a sealing portion.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is a cross sectional view of a particle damping assembly according to one arrangement;

FIG. 2A is a cross sectional view of another particle damping assembly;

FIG. 2B is a perspective cut-away view of a particle damping assembly, such as the particle damping assembly illustrated in FIG. 2A;

FIG. 2C is another perspective cut-away view of a particle damping assembly, such as the particle damping assembly illustrated in FIG. 2A;

FIG. 2D is another perspective view of a particle damping assembly, such as the particle damping assembly illustrated in FIG. 2A;

FIG. 2E is a perspective view of a sealing portion for use with a particle damping assembly, such as the particle damping assembly illustrated in FIG. 2A;

FIG. 3A is a cross sectional view of another particle damping assembly embodiment;

FIG. 3B is another perspective cut-away view of another particle damping assembly, such as the particle damping assembly illustrated in FIG. 3A;

FIG. 3C is another perspective cut-away view of a particle damping assembly, such as the particle damping assembly illustrated in FIG. 3A;

FIG. 3D is bottom perspective view of another particle damping assembly, such as the particle damping assembly illustrated in FIG. 3A;

FIG. 4A is a cross sectional view of another particle damping assembly embodiment;

FIG. 4B is another perspective cut-away view of another particle damping assembly, such as the particle damping assembly illustrated in FIG. 4A;

FIG. 4C is another perspective cut-away view of a particle damping assembly, such as the particle damping assembly illustrated in FIG. 4A;

FIG. 4D is bottom perspective view of another particle damping assembly, such as the particle damping assembly illustrated in FIG. 4A;

FIG. 5 illustrates various views of a speaker supported by a particle damping system;

FIG. 6A illustrates a cross sectional view of a HiFi isolator for HiFi equipment using a particle damping system; and

FIG. 6B is a front plan view of a piece of electronic hi-fi equipment supported by a hi-fi isolator foot incorporating a particle damping system of a type shown in FIG. 6A.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In one preferred arrangement, the present disclosure will be used in a vibration isolation foot for loudspeakers. In typical usage it will be used under floor-standing loudspeakers, stands for stand-mount speakers, and under bookshelf speakers. 3 or 4 would be used with threaded attachments to ensure full coupling to the speaker where possible. The design combines a rigid case to provide the coupling to the floor or support surface with multi-frequency particle impact dampening chambers to dissipate vibration.

In one preferred arrangement, the present disclosure will be used in a vibration isolation foot for hi-fi equipment placed on racks, shelves, and platforms. In a typical usage case, 3 or 4 of the feet would be placed underneath hi-fi equipment such as CD players, DACs, network streamers, phono amplifiers, pre-amplifiers, power amplifiers, integrated amplifiers, tuners, integrated streamer/amplifier combinations and turntables.

In one arrangement, the present disclosure combines a multi-frequency particle impact dampening (MFPID) chamber or container in an assembly to dampen vibration when placed under a piece of hi-fi equipment. This assembly can be referred to as a ‘MFPID hi-fi equipment isolator’.

In various embodiments as disclosed herein, embodiments utilize a plurality of cavities or containers that are filled with varying particle sizes for broad-spectrum vibration dampening. These plurality container designs helps to ensure an efficient response to a range of frequencies, thereby enhancing overall sound quality.

For example, particle damping or Particle Impact Damping (“PID”) is used to reduce or control vibration. One size and type of particle may be used to reduce vibration. However, particles of different sizes may better control the range of vibrations, namely, 20 Hz-20,000 Hz, because vibrations of various sources may need to be controlled, so that the sound, namely, the music, is produced as desired. Therefore, Multi-Frequency Particle Impact Damping (“MFPID”) is used in various disclosed arrangements. MFPID uses different sizes of particles to control different ranges of vibrational frequency, measured in Hertz (Hz) within one or more selected ranges, desirably within 20 Hz-20,000 Hz.

The 20 Hz to 20 kHz range can be important as that covers the frequencies produced by a typical full range hi-fi loudspeaker. The lowest frequencies often produce strong physical vibrations that can be felt, especially when loud, while the higher frequencies contribute to the perception of pitch and detail in sound. In a stereo room system, the high frequencies also contribute to the perception of a 3-dimensional sound stage and the precision of the placement of individual instruments and vocals within that sound stage. This is an aspect of the sound that is often very important audiophiles (both listeners and reviewers).

As well as covering a wide frequency range, loudspeakers produce complex multi-axis vibrations, including vertical, horizontal, and rotational motions. These vibrations, influenced by audio content and speaker design, travel from the speaker through its feet to the contacting surface. This affects sound quality and speaker-environment interactions.

For effective multi-axis PID absorption, specific containers or chambers within the embodiment are designed to optimize vertical contact for vertical vibrations and horizontal contact for horizontal vibrations.

The multiple chambers filled with different sizes of particles address both the frequency range and direction of vibration challenges for the design of a PID loudspeaker isolator. These multiple chambers can have different fill rates. As just one example, one chamber or container may be filled at about 100% while a second chamber or container may be filled at a different fill rate, such as at about 70%. As those of ordinary skill in the art will recognized, alternative fill rates for different chamber or containers may be utilized as well.

PID works on the principle of the particles making contact with the chamber walls and being excited by the vibrational energy. The advantages of using multiple smaller chambers instead of one large chamber are multiple.

For example, such chambers or containers result in reduced inertia. For example, dispersing particles across several chambers rather than concentrating them in one large chamber, each individual chamber or container contains particles with a reduced collective mass. This reduced mass means that the particles within each chamber have less inertia and can be more easily excited or set into motion by an external force or vibration.

Moreover, multiple chamber or container embodiments also enhance responsiveness. That is, with the particles being more easily excited due to reduced inertia, the chambers or containers can be more responsive to a wider range of vibration intensities. A smaller force will be sufficient to cause meaningful particle-wall interactions in these chambers.

Multiple chamber arrangements also provide for increased surface interactions. When particles are distributed across multiple chambers, there are more particle-wall interactions in each chamber.

In addition, multiple chamber or container arrangements can also optimized for different frequencies: Different chamber or container sizes, coupled with the reduced mass of particles in them, can be optimized to respond to various frequencies. Smaller chambers or containers with fewer particles will be more responsive to higher frequencies, while larger chambers or containers will be more effective with lower frequencies.

Small MFPID particles, or fine powder-like materials, are between about 0.0001 mm and about 0.3 mm in diameter. Small particles dissipate high-frequency vibrations as their reduced inertia allows for rapid movement, facilitating frequent collisions with both each other and the chamber walls. This movement transforms the vibrational energy predominantly into heat, effectively reducing the vibrational impact at these frequencies.

Medium MFPID particles are between about 0.3 mm and about 0.8 mm in diameter. Medium particles dissipate the mid-range frequencies as their size gives them a balance of inertia and mobility, enabling them to effectively mitigate vibrations within this frequency range.

Large MFPID particles are between about 0.8 mm and about 4 mm. Large particles have the greatest inertia and absorb the lower-frequency vibrations, with their more substantial mass and slower movement attuned to the longer wavelengths.

In the detailed descriptions of the embodiments and figures that follow, all the references to Small, Medium and Large MFPID particles should be understood to mean the dimensions described above.

In one arrangement, the PID hi-fi equipment isolator comprises a machined outer metal body enclosing a single ring-shaped chamber or container containing particles for PID with a larger open container. In one arrangement, there is a threaded hole drilled into the center at the top of the metal body surrounded by the PID chamber. In one preferred arrangement, the machined body comprises an aluminum or stainless-steel body.

In one preferred arrangement, the PID chamber contains a plurality of particles that turn the kinetic energy from vibrations into heat through movement and collisions. This is generally an underlying principle of particle impact. In one preferred arrangement, the PID chamber may be sealed or enclosed with a fixed metal plate.

The particles may be formed from at least one of stainless steel, carbon steel, iron, tungsten, glass, and ceramic. In one preferred arrangement, the particles comprise a particle size of about 0.0001 millimeters to about 4.0 millimeters.

The PID chamber absorbs vibrations coming from the hi-fi equipment's case. This could be generated internally by, for example, power supplies or has been transmitted by air-borne sound waves.

The threaded bolt provides full coupling of the particle damping assembly with a loudspeaker and further provides height adjustment.

FIG. 1 is a cross sectional view of a particle damping assembly 110 according to one arrangement. In this first embodiment of an isolator or damping assembly 110, this isolator or damping assembly 110 may be utilized with various types of device such as audio devices, such as an audio speaker. However, as those of ordinary skill in the art will recognize, alternative applications and damping utilizations may be utilized as well.

The damping assembly 110, in this illustrated arrangement, is used to control vibration in an apparatus of a speaker, as illustrated in FIG. 1, a connector 111 from a speaker is connected at one end to a foot 112. The foot 112 includes a housing 113, and inside of the housing 113 may desirably be at least one or a plurality of small containers 114, at least one or a pair of medium-sized containers 116, and one or a pair of large containers 118. Each container of the pair of containers 114, 116, 118, respectively, may be made from metal, and in this example, computer numerical control (hereinafter “CNC”) milled aluminum pockets or containers. The containers 114, 116, 118 may be stacked one on top of another, as illustrated, or they may be configured to be positioned side-by-side. Each of the pairs of small, medium, and large containers 114, 116, 118, respectively, contain MFPID particles 20.

For example, but not by way of limitation, the MFPID particles 120 in the pair of large containers 218 are large MFPID particles 122. The MFPID particles 120 in the pair of medium-sized containers 116 are medium-sized particles 124. The MFPID particles 120 in the pair of small containers 114 are small MFPID particles 126.

The Small MFPID particles 126 may comprise a fine powder made from at least one of tungsten, steel, lead, glass, iron, and the like, which is used primarily to absorb higher frequency vibrations. Medium sized MFPID particles 124 and large sized MFPID particles 122 may be used to absorb medium and lower frequency vibrations, respectively. The medium MFPID particles 124 and the large MFPID particles 122 may also be made metal, such as stainless steel, tungsten, glass, ceramic, iron, normal or carbon steel, and the like.

The containers 114, 116, 118 may also be separated by an insert 128 positioned between the containers 114, 116, 118, and which may also be positioned in other positions, such as, by way of non-limiting example, below the containers 114, 116, 118, around the containers 114, 116, 118, above the containers 114, 116, 118, and the like. The insert may be removably or non-removably affixed into the various containers, such as, for example, snap fit, glued, or otherwise adhered within a preferred location and orientation. The insert will typically be made up of metal or another hard material. It is designed to transfer vibration into the particles, seal the container and act as a hard wall for the particles to react against. Further, while the containers 114, 116, 118 are shown as pairs, it will be understood that the containers 114, 116, and/or 118 may be a single circular container, a circular container with a center opening therethrough, semi-circular containers, square and/or U-shaped containers, or any shape and/or size or combination of shapes and/or sizes.

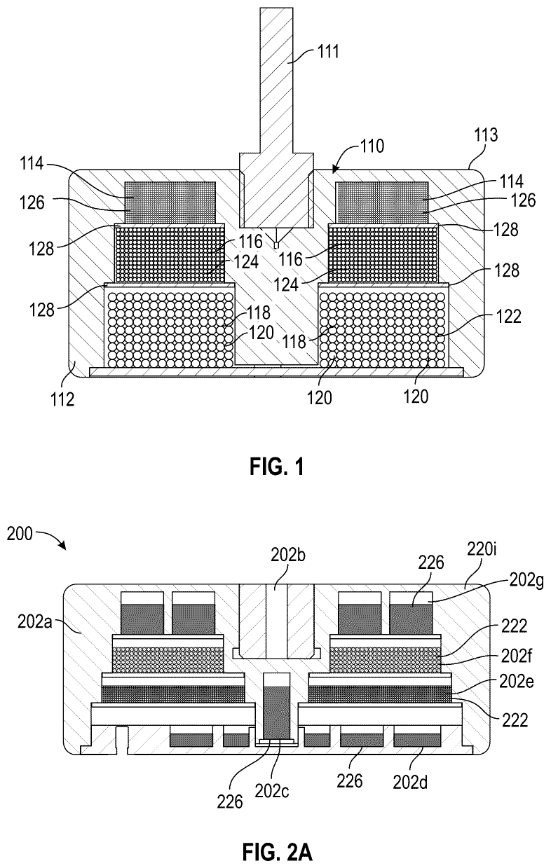

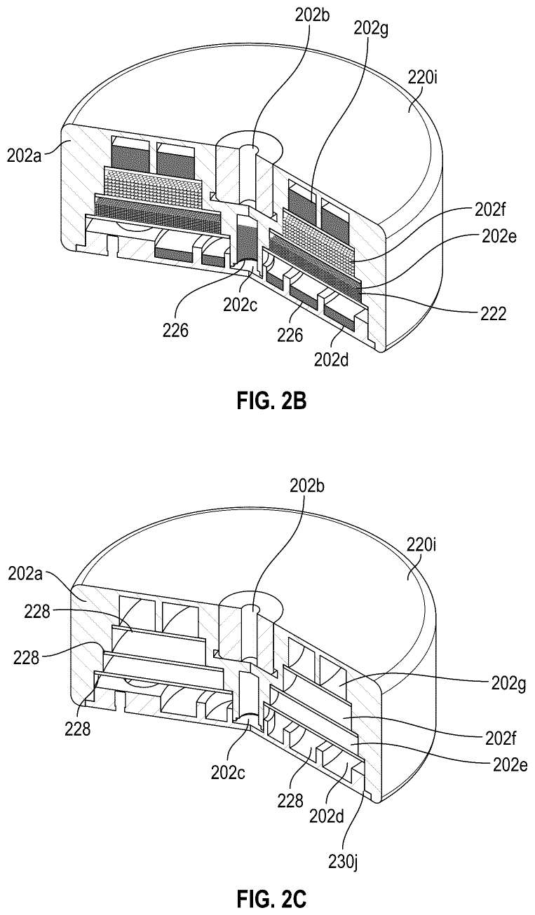

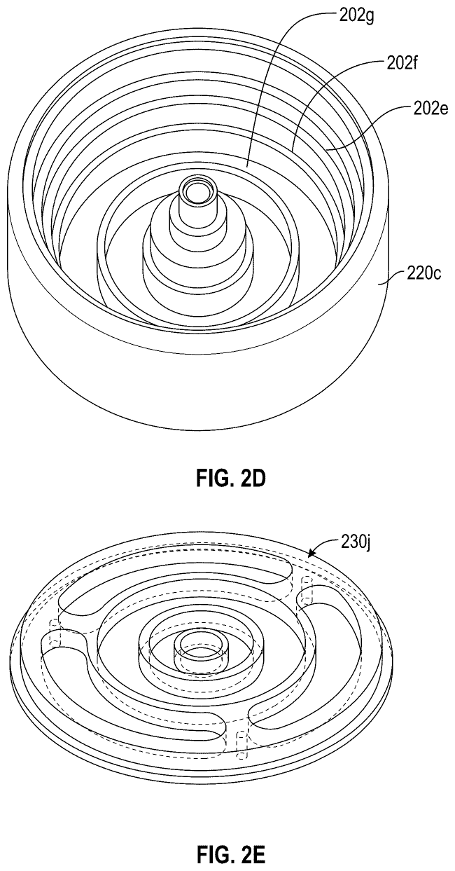

FIG. 2A is a cross sectional view of another particle damping assembly 200. FIG. 2B is a perspective cut-away view of a particle damping assembly, such as the particle damping assembly 200 illustrated in FIG. 2A. FIG. 2C is another perspective cut-away view of a particle damping assembly, such as the particle damping assembly 200 illustrated in FIG. 2A. FIG. 2D is another perspective view of a particle damping assembly, such as the particle damping assembly 200 illustrated in FIG. 2A. And FIG. 2E is a perspective view of a sealing portion 230j for use with a particle damping assembly, such as the particle damping assembly illustrated in FIG. 2A.

Referring now to FIGS. 2A, 2B, 2C, 2D and 2E, the particle damping assembly 200 comprises a housing 202a. A central opening 202b is provided for a speaker connector. A vertical central chamber 202c is provided below the opening, and it is desirably filled with MFPID particles, such as small WPM particles 226. A plurality of lower circular rings 202d are filled with small MFPID particles 226 as well. Moving upward from circular rings 202d, circular ring 202e is filled large MFPID particles 222. Continuing upwardly from circular ring 202e, circular ring 202f is desirably filled with large MFPID particles 222. Continuing upward from circular ring 202f, near an upper end of the housing 202a are a plurality of rings of circular or semi-circular orientation 202g which are filled with small MFPID particles 226.

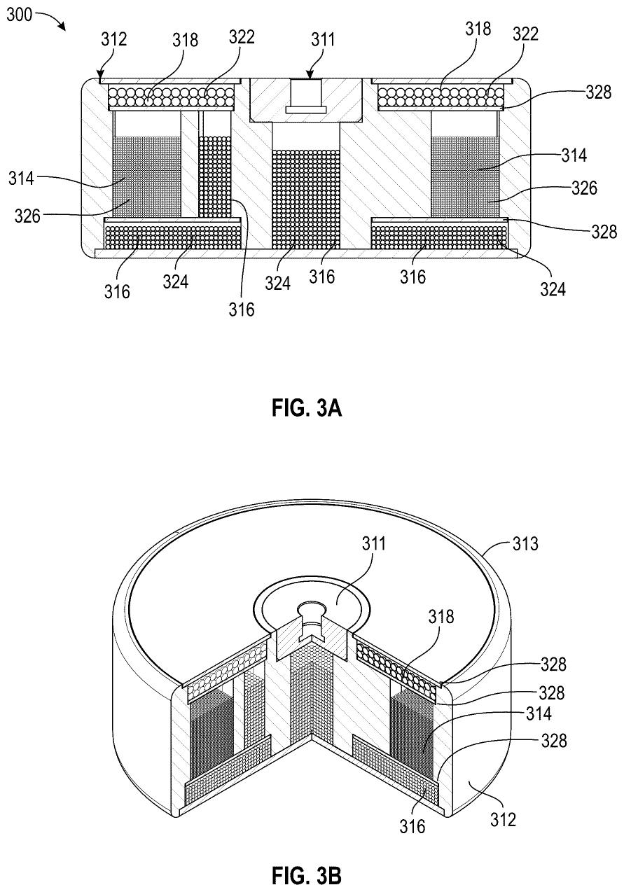

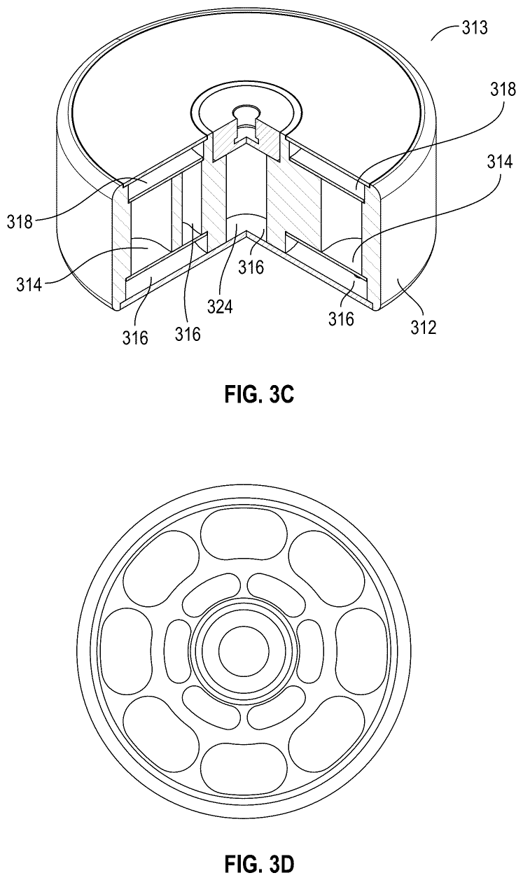

FIG. 3A illustrates a cross sectional view of another particle damping assembly embodiment 300. FIG. 3B is another perspective cut-away view of another particle damping assembly, such as the particle damping assembly 300 illustrated in FIG. 3A. FIG. 3C is another perspective cut-away view of a particle damping assembly, such as the particle damping assembly 300 illustrated in FIG. 3A. And FIG. 3D illustrates a bottom perspective view of another particle damping assembly, such as the particle damping assembly 300 illustrated in FIG. 3A.

Referring now to the particle damping assembly 300 as illustrated in FIGS. 3A, 3B, 3C, 3D, this damping assembly 300 may be used in various applications, such as applications used to control vibration in an apparatus of a speaker. As illustrated, the assembly 300 may comprise an insert for a speaker thread 311 is connected at one end to a foot 312. The foot 312 includes a housing 313, and inside of the housing 313 may desirably be at least one or a plurality of small containers 314, at least one or a plurality of medium-sized containers 316, and one or a plurality of large containers 318. Each of containers 314, 316, 318, respectively, may be made from metal or other material, and in this example, computer numerical control (hereinafter “CNC”) milled aluminum pockets or containers. The containers 314, 316, 318 may be stacked one on top of another, as illustrated, or they may be configured to be positioned side-by-side. Each of the small, medium, and large containers 314, 316, 318, respectively, contain MFPID particles.

For example, but not by way of limitation, the MFPID particles 320 in the large containers 318 are large MFPID particles 322. The MFPID particles 320 in the medium-sized containers 316 are medium-sized particles 324. The MFPID particles 320 in the small containers 314 are small MFPID particles 326. The containers 314, 316, 318 may or may not have volumes that are not substantially the same.

The MFPID particles 320 may comprise a fine powder made from at least one of tungsten, steel, lead, glass, iron, and the like, which is used primarily to absorb higher frequency vibrations. Medium sized MFPID particles 324 and large sized WPM particles 322 may be used to absorb medium and lower frequency vibrations, respectively. The medium MFPID particles 324 and the large MFPID particles 22 may also be made metal, such as stainless steel, tungsten, glass, ceramic, iron, normal or carbon steel, and the like.

The containers 314, 316, 318 may also be separated by an insert 328 positioned between the containers 314, 316, 318, and which may also be positioned in other positions, such as, by way of non-limiting example, below the containers 314, 316, 318, around the containers 314, 316, 318, above the containers 314, 316, 318, and the like. The insert will typically be made up of metal or another hard material. It is designed to transfer vibration into the particles, seal the container and act as a hard wall for the particles to react against. Further, it will be understood that the containers 314, 316, and/or 318 may be a single circular container, a circular container with a center opening therethrough, semi-circular containers, square and/or U-shaped containers, or any shape and/or size or combination of shapes and/or sizes.

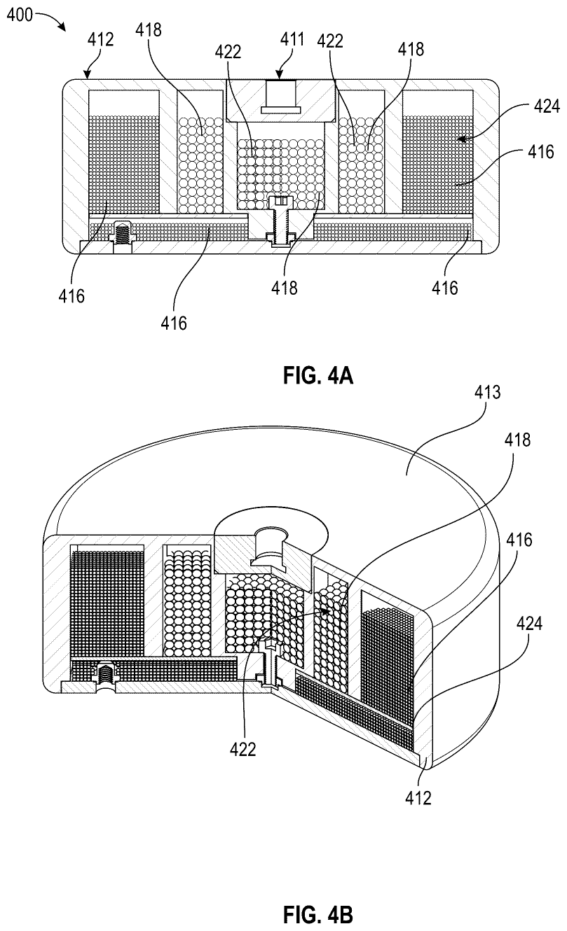

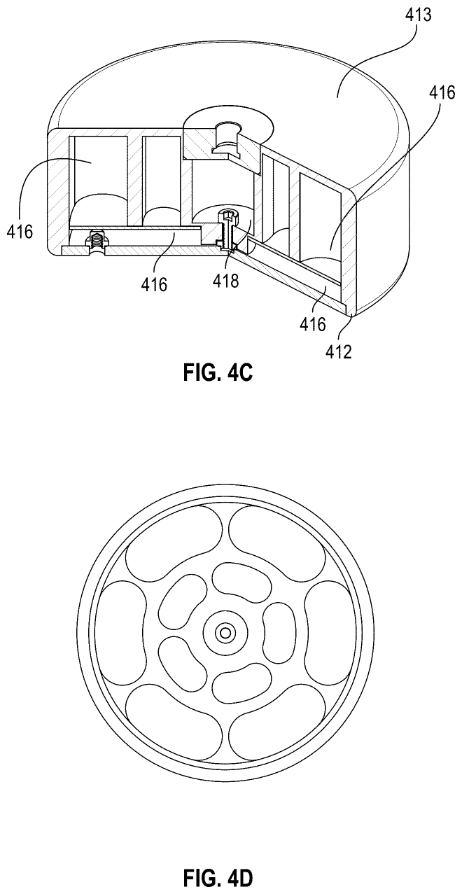

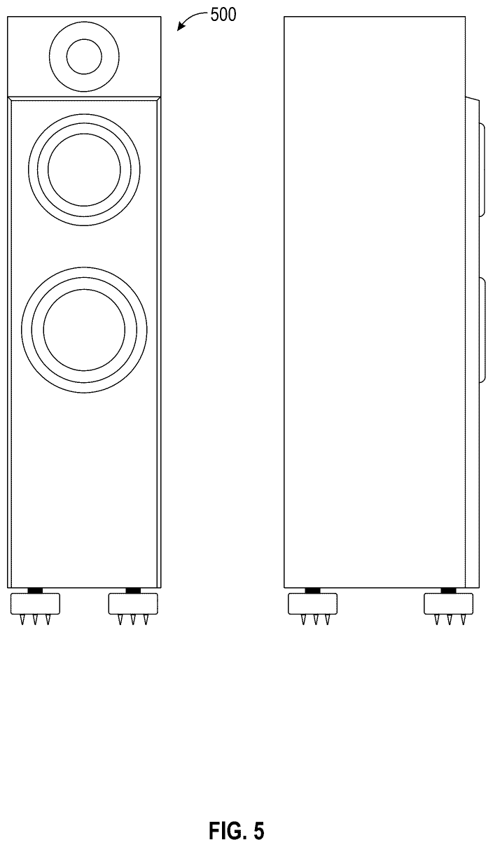

FIG. 4A illustrates a cross sectional view of another particle damping assembly embodiment 400. FIG. 4B is another perspective cut-away view of another particle damping assembly, such as the particle damping assembly 400 illustrated in FIG. 4A FIG. 4C is another perspective cut-away view of a particle damping assembly, such as the particle damping assembly 400 illustrated in FIG. 4A. And FIG. 4D illustrates a bottom perspective view of a particle damping assembly, such as the particle damping assembly 400 illustrated in FIG. 4A.

Referring now to FIGS. 4A-D, as illustrated, the particle damping assembly 400 comprises speaker isolator or damping assembly 400 to control vibration in an apparatus of a speaker. As illustrated, the damping assembly 400 comprises an insert for a speaker thread 411 is connected at one end to a foot 412. The foot 412 includes a housing 413, and inside of the housing 413 may desirably be at least one or a plurality of medium-sized containers 416, and one or a plurality of large containers 418. Each of containers 416, 418, respectively, may be made from metal or other material, and in this example, computer numerical control (hereinafter “CNC”) milled aluminum pockets or containers. The containers 416, 418 may be stacked one on top of another, as illustrated, or they may be configured to be positioned side-by-side. Each of the small, medium, and large containers 416, 418, respectively, contain MFPID particles 420. The containers 416, 418 may or may not have volumes that are not substantially the same.

For example, but not by way of limitation, the MFPID particles 420 in the large containers 418 are large MFPID particles 422. The MFPID particles 420 in the medium-sized containers 416 are medium-sized particles 424.

The containers 416, 418 may also be separated by an insert 428 positioned between the containers 416, 418, and which may also be positioned in other positions, such as, by way of non-limiting example, below the containers 416, 418, around the containers 416, 418, above the containers 416, 418, and the like. The insert will typically be made up of metal or another hard material. It is designed to transfer vibration into the particles, seal the container and act as a hard wall for the particles to react against.

Further, it will be understood that the containers 416, and/or 418 may be a single circular container, a circular container with a center opening therethrough, semi-circular containers, square and/or U-shaped containers, or any shape and/or size or combination of shapes and/or sizes.

FIG. 5 illustrates various views of a speaker supported by a plurality of particle damping assemblies, such as the damping assemblies described and/or illustrated herein. For example, FIG. 5 illustrates both a front and side view of a speaker 530 supported by a plurality of particle damping assemblies. A speaker 530 includes isolator feet such as the two-part (or a multi-part) HiFi Isolator (or “foot”) shown and described in detail herein (the two-part isolator including circular portion housing and cylindrical portion housing). In this example, containers carrying MFPID particles are desirably positioned about internal parts for reducing or eliminating internal vibrations from the one or more containers held within the housing.

One of the reasons the proposed loudspeaker isolator works well is because it is rigid (the machined aluminum outer case) as well as providing vibration absorption in the internal MFPID chambers or containers.

Traditionally there are two opposite approaches to supporting loudspeakers in situ—coupling or de-coupling. Coupling typically uses metal spikes or cones that hold the loudspeaker rigidly to ensure there is minimal movement and physically connecting the loudspeaker to the floor. Most floor standing loudspeakers and speaker stands come with spikes. Coupling has the benefit of ensuring the loudspeaker cabinet does not move forwards or backwards with the movement of the speaker cones/drivers. In sonic terms, this helps with fine detail clarity and the perception of a precise 3-dimensional soundstage for stereo listening. However, it is a misconception that spikes provide counter vibration by allowing energy to travel only one direction because the end of the spike is pointed. In fact, just as vibration travels down the spike into the floor, the spike also transmits any floor vibrations back up into the speaker through the same fine point the vibrations have drained through. In reality, coupling provides no vibration absorbing capability.

De-coupling typically uses a compliant material (e.g., elastomer, springs, rubber cones, foam) that attempts to isolate the speaker from the listening room floor, absorbing some of the vibration. However, this isolation removes the rigid coupling to the floor provided by spikes and allows the loudspeaker cabinet to move as a result of the energy from the speaker drivers.

For speakers to work effectively, one needs to satisfy two seemingly contradictory aims: hold the loudspeaker perfectly rigidly whist absorbing vibration at the same time. The presently disclosed embodiments are both rigid, providing the benefits of coupling to prevent movement of the speaker, whilst absorbing speaker cabinet vibration internally through the PID. This is one fundamental principle of the design of the arrangements illustrated and described in the present disclosure.

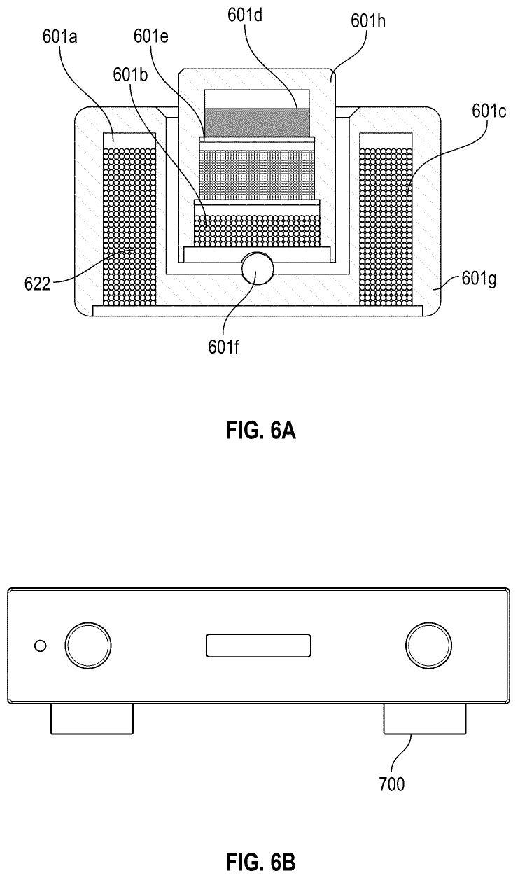

FIG. 6A illustrates a cross sectional view of a HiFi isolator for HiFi equipment using a particle damping system. Referring now to FIG. 6A, a HiFi isolator support is illustrated. The HiFi isolator foot or support may be used to support HiFi equipment, namely, sensitive electronic and digital components, such as, for example only, a CD player, an amplifier, and the like. The HiFi isolator support include two parts: a circular portion and housing 601h having a central opening therein, and a closed cylindrical portion and housing 601g which is held within the opening but spaced-apart from the interior perimeter wall. A lower end of the circular portion housing 601h includes, for example, but not by way of limitation, a hemispheric-shaped concave groove. Similarly, a lower end of the cylindrical portion housing 1g also includes a hemispheric-shaped concave groove in axial alignment with the groove of the circular portion housing 601h. A round ball 601f is desirably positioned between the two grooves, to permit the cylindrical portion housing 601g to move within the opening of the circular portion housing 601h. A pair of tall chambers, a semi-circular chamber, or a circular chamber 601a is positioned in the circular portion housing 601a. The chamber(s) 601a may desirably be filled with large MFPID particles 622, and the chamber may be 70-99 percent filled.

A lower end of the cylindrical portion housing 601h includes a lower chamber which may also desirably be filled with large MFPID particles, and the chamber may be 80 percent filled. Immediately above the lower chamber is a center chamber which is 90 percent filled with medium MFPID particles 624. And above the center chamber is an upper chamber which may be 65 percent filled with small MFPID particles 626. Both the circular portion housing 601h and the cylindrical portion housing 601g may desirably be formed from aluminum or stainless steel. Similarly, the center chamber and the lower chamber may each include an aluminum cap to close each chamber. The circular portion housing 601g rests on a holder for the HiFi equipment, and desirably absorbs low frequency vibrations.

The spherical ball 601f permits the cylindrical portion housing 601h to move and permits multi-axis movement for vibration dissipation.

FIG. 6A illustrates a cross sectional view of a HiFi isolator for HiFi equipment using a particle damping assembly 700. HiFi Equipment is sensitive electronic and digital components, such as, for example, but not by way of limitations, a CD player, a tuner, an amplifier, and the like. FIG. 6B is a front plan view of a piece of electronic hi-fi equipment supported by a hi-fi isolator foot incorporating a particle damping system of a type shown in FIG. 6A. In this instance, the equipment is placed directly on top of the isolators with no additional or permanent attachment. A plurality of damping assemblies (e.g., 3 or 4 isolators) may be positioned and used to support the equipment to optimize both stability and vibration isolation.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. As just one example, and as those of ordinary skill in the art will recognize, various alternative cell and container illustrated arrangements may be re-arranged and different types and configurations of PIDs in terms of vertical and horizontal configurations may be utilized. In addition, various types of PIDs, and PID chamber sizes and shapes, and particle sizes may also be utilized consistent with the scope and nature of the presently disclosed systems, methods and apparatus disclosed herein.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. A particle damping assembly, the assembly comprising:
a housing;
a plurality of containers positioned within the housing, the plurality of containers configured to hold a plurality of particles for particle impact damping of vibrations; and
one or more sizes of particles, each size of particle held within the plurality of containers.

2. The assembly of claim 1 wherein the plurality of containers comprises a first container and a second container wherein the first container is stacked on top of the second container.

3. The assembly of claim 2 wherein the plurality of containers comprises a third container wherein the second container is stacked on top of the third container.

4. The assembly of claim 3 wherein the plurality of containers comprises a fourth container wherein the third container is stacked on top of the fourth container.

5. The assembly of claim 2 further comprising a third container, wherein the third container is positioned in adjacent the first container and the second container.

6. The assembly of claim 1 wherein the plurality of containers comprises a first container and a second container wherein the first container and the second container are positioned side-by-side each other.

7. The assembly of claim 6 further comprising a third container wherein the third container is positioned adjacent either the first container or the second container.

8. The assembly of claim 6 further comprising a third container wherein the third container is positioned in between the first container or the second container.

9. The assembly of claim 1 further comprising:
an insert positioned between a first container and a second container of the plurality of containers.

10. The assembly of claim 1 further comprising an insert positioned between a surface of a housing of a component of a sound system and at least one of the plurality of containers.

11. The assembly of claim 1, wherein at least one of the containers of the plurality of containers is formed from aluminum, stainless steel, or plastic.

12. The assembly of claim 1, wherein the particles are formed from at least one of steel, iron, tungsten, glass, and ceramic.

13. The assembly of claim 1, wherein the particles have a size in a range of about 0.0001 millimeters to about 4.0 millimeters.

14. The assembly of claim 1, wherein the particles comprise multi-frequency impact dampening particles.

15. The assembly of claim 1 wherein at least one of the plurality of containers comprises a ring-shaped container containing the particle impact dampeners.

16. The assembly of claim 1 wherein the housing comprises a machined metal housing or a stainless-steel main housing.

17. The assembly of claim 1 wherein the dampeners comprise a particle size ranging from about 0.0001 millimeters to about 4.0 millimeters.

18. The assembly of claim 1 wherein the assembly comprises an assembly for dampening vibration in a sound system.

19. The assembly of claim 1 wherein a first container of the plurality of containers defines a first volume and a second container of the plurality of containers defines a second volume, wherein the second volume is not substantially the same as the first volume.

20. The assembly of claim 1 wherein the housing defines a first surface, wherein the first surface is provided with a sealing portion.
